(19) United States
(12) Patent Application Publication
(10) Pub. No.: US 2026/0236789 A1
(43) Pub. Date: Aug. 13, 2026

(54) METHOD AND APPARATUS WITH HYPERPARAMETER DETERMINATION

(71) Applicant: SAMSUNG ELECTRONICS CO., LTD., Suwon-si (KR)

(72) Inventors: Kikyung KIM, Suwon-si (KR); Saehyun AHN, Suwon-si (KR); Chanho AHN, Suwon-si (KR); Seungju HAN, Suwon-si (KR); Sungjoo SUH, Suwon-si (KR)

(73) Assignee: SAMSUNG ELECTRONICS CO., LTD., Suwon-si (KR)

(21) Appl. No.: 19/532,319

(22) Filed: Feb. 6, 2026

(30) Foreign Application Priority Data
Feb. 7, 2025 (KR) 10-2025-0016217
Feb. 5, 2026 (KR) 10-2026-0023900

(51) Int. Cl. G06N 3/0985; G06N 3/0455; G06T 7/00

(52) U.S. Cl. CPC G06N 3/0985; G06N 3/0455; G06T 7/0004

(57) ABSTRACT

A method performed by one or more processors for determining an optimal hyperparameter value for a hyperparameter among hyperparameters of an artificial intelligence (AI) model, the method including: performing first pre-trainings of the AI model using a first low-resolution image set according to sets of values of hyperparameters, each set of values including values respectively corresponding to the hyperparameters, wherein the low-resolution image set includes first low-resolution images that are low-resolution relative to a resolution that the AI model is capable of performing inference on; performing first fine-tunings of the AI model using a second low-resolution image set, wherein the first fine-tunings are performed according to the respectively corresponding sets of values of the hyperparameters; and determining the optimal hyperparameter value based on metrics of performance of the AI model for which the first pre-trainings and the first fine-tunings have been performed.

### CROSS-REFERENCE TO RELATED APPLICATIONS

This application claims priority to and the benefit under 35 USC § 119 (a) of Korean Patent Application No. 10-2025-0016217 filed with the Korean Intellectual Property Office on Feb. 7, 2025 and No. 10-2026-0023900 filed with the Korean Intellectual Property Office on Feb. 5, 2026 and, the entire contents of which are incorporated herein by reference.

### BACKGROUND

### 1. Field

The present disclosure relates to a method and an apparatus for searching a hyperparameter for training an AI model.

### 2. Description of Related Art

Training AI model training is usually performed according to a hyperparameter set by a user, and the hyperparameter is not automatically adjusted during the training of the model. Because a hyperparameter greatly affects the speed of training a model, as well as the performance of the trained model, the hyperparameter needs to be appropriately set to optimize the model for a domain and prevent overfitting of the model to its training data.

When an input image domain is changed in discrimination or classification of the image, the AI model may be generally pre-trained and fine-tuned. That is, the AI model may train (pre-train) a basic feature of the changed domain using an image set with relatively large images, and may fine-tune the pre-trained model for a specific task using a labeled image set with relatively small images.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a method is performed by one or more processors for determining an optimal hyperparameter value for a hyperparameter among hyperparameters of an artificial intelligence (AI) model, and the method includes: performing first pre-trainings of the AI model using a first low-resolution image set according to sets of values of hyperparameters, each set of values including values respectively corresponding to the hyperparameters, wherein the low-resolution image set includes first low-resolution images that are low-resolution relative to a resolution that the AI model is capable of performing inference on; performing first fine-tunings of the AI model using a second low-resolution image set, wherein the first fine-tunings are performed according to the respectively corresponding sets of values of the hyperparameters; and determining the optimal hyperparameter value based on metrics of performance of the AI model for which the first pre-trainings and the first fine-tunings have been performed.

The performing first pre-trainings of the AI model using the first low-resolution image set according to sets of values of the hyperparameters may include performing the first pre-trainings using first images of a first database and the first low-resolution images having a resolution relatively lower than the first images of the first database.

The performing the first pre-trainings using the first images of the first database and the first low-resolution images having a resolution relatively lower than the first images of the first database includes: calculating a first loss using one of the first low-resolution images; calculating a second loss using one of the first images of the first database; and updating an encoder of the AI model based on the first loss and the second loss.

One of the hyperparameters may be a mask ratio that controls how many patches of the one of the first low-resolution images are masked, and wherein the calculating of the first loss using the one of the first low-resolution images includes: inputting, to the encoder, a non-masked patch of the one of the first low-resolution images, wherein the non-masked patch is determined to be non-masked according to a value of the mask ratio, wherein the value of the mask ratio is one of the value sin the sets of values; adding a low-resolution mask token to tokens output from the encoder and inputting the tokens with the low-resolution mask token to a first decoder of the AI model which generates a low-resolution reconstructed image based thereon; and calculating the first loss based on a difference between the one of the first low-resolution images and the low-resolution reconstructed image.

The inputting the non-masked patch to the encoder may include: converting the non-masked patch into an embedding vector; and adding to the embedding vector a positional embedding indicating positional information of the unmasked patch and inputting the embedding vector with the positional embedding to the encoder.

The calculating the second loss using the one of the first images of the database may include: adding a high-resolution mask token to second tokens outputted from the encoder based on the one of the first images of the database, and inputting the second tokens to which the high-resolution mask token is added to a second decoder of the AI model that generates a second reconstructed image based thereon; and calculating the second loss based on a difference between the one of the first images and the second reconstructed image.

The first loss may be determined based on a comparison between the low-resolution reconstructed image and a portion of the one of the first low-resolution images that corresponds to masked patches in the one of the first low-resolution images, and the second loss may be determined based on a comparison between the second reconstructed image and a portion of the one of the first images of the database that correspond to masked patches in the one of the first images of the database.

The method may further include: performing second pre-training on the AI model with the optimal hyperparameter value using a first high-resolution image set of images that are higher resolution than the images in the low-resolution image set; and performing second fine-tuning on the AI model with the optimal hyperparameter value using a second high-resolution image set of images that are higher resolution than the images in the low-resolution image set.

The method may further include: performing downconversion for images in a first database to generate the first low-resolution image set; and performing downconversion for images in a second database to generate the second low-resolution image set, wherein the first database stores unlabeled images and the second database stores labeled images.

In another general aspect, an apparatus for determining an optimal hyperparameter value includes: one or more processors and a memory, wherein the memory stores instructions configured to cause the one or more processors to perform a process, and the process includes: performing a low-resolution image set based pre-training and a low-resolution image set based fine-tuning on an artificial intelligence (AI) model for each of hyperparameter sets of values of hyperparameters, wherein a low-resolution image set based pre-training and a low-resolution image set based fine-tuning are performed for each set of values of the hyperparameters, wherein a performance metric of the AI model is determined for each low-resolution image set based pre-training and its corresponding a low-resolution image set based fine-tuning, and wherein the low-resolution image set is low-resolution relative to a resolution that the AI model is capable of performing inference on; and determining the optimal hyperparameter value based on the performance metrics of the AI model.

The performing each low-resolution image set based pre-training and its corresponding a low-resolution image set based fine-tuning on the AI model according to the sets of hyperparameter values may include: performing each pre-training on the AI model using a first image of a first database and a first low-resolution image downconverted from the first image; and performing each fine-tuning on the AI model using a second image of a second database and a second low-resolution image downconverted from the second image.

The performing each pre-training on the AI model using a first image of the first database and a first low-resolution image downconverted from the first image may include: calculating a first loss using the first low-resolution image; calculating a second loss using the first image; and updating an encoder of the AI model based on the first loss and the second loss.

The calculating the first loss using the first low-resolution image may include: inputting, to the encoder, a non-masked patch that is determined to be not masked in the first low-resolution image according to a mask ratio value, wherein the mask ratio value is a value in one of the sets of values; adding a low-resolution mask token to tokens outputted from the encoder and inputting the tokens including the low-resolution mask token to a first decoder of the AI model which infers a low-resolution reconstructed image based thereon; and calculating the first loss based on a difference between the first low-resolution image and the low-resolution reconstructed image.

The calculating the second loss using the first image may include: adding a high-resolution mask token to first tokens output from the encoder and inputting, to a second decoder of the AI model, the first tokens including the high-resolution mask token, wherein the second decoder outputs a reconstructed image based on the first tokens including the high-resolution mask token; and calculating the second loss based on a difference between the first image and the reconstructed image.

The first loss may be determined based on a comparison between the low-resolution reconstructed image and a portion of the first low-resolution image corresponding to masked patches in the first low-resolution image, and the second loss may be determined based on a comparison between the reconstructed image and a portion of the first image corresponding to masked patches in the first image.

The process may further include performing pre-training and fine-tuning on the AI model with the optimal hyperparameter value using high-resolution image sets.

In another general aspect, a system for detecting a defect in a semiconductor manufacturing process includes: a photographing apparatus configured to photograph an image of a wafer during the semiconductor manufacturing process; and a defect detection apparatus configured to detect a defect in the image using an AI model, wherein the AI model is trained to classify an image of a new domain through low-resolution image set based pre-training and fine-tuning and high-resolution image set based pre-training and fine-tuning, wherein the low-resolution image set has lower resolution than the high-resolution image set.

A hyperparameter value for training the AI model may be determined through the low-resolution image set based pre-training and the fine-tuning, and the high-resolution image set based pre-training and the fine-tuning are performed using the hyperparameter value determined in the low-resolution image set based pre-training and the fine-tuning.

The AI model may include a masked vision transformer neural network.

The AI model may be trained according to a loss computed by comparing regions of a training image that were masked for the pre-training or the fine-tuning with positionally corresponding regions of an image reconstructed for the training image.

Other features and aspects will be apparent from the following detailed description, the drawings, and the claims.

### BRIEF DESCRIPTION OF THE DRAWINGS

FIG. 1 illustrates a training apparatus of an AI model according to one or more embodiments.

FIG. 2 illustrates a training method of the AI model according to one or more embodiments.

FIG. 3 and FIG. 4 illustrate a low-resolution image set based pre-training method on the AI model according to one or more embodiments.

FIG. 5 illustrates a defect detection system of a semiconductor manufacturing process according to one or more embodiments.

FIG. 6 illustrates a structure of a vision transformer according to one or more embodiments.

FIG. 7 illustrates a controller for pre-training and fine-tuning on the AI model according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

An artificial intelligence (AI) model of the present disclosure may be a machine training model that trains at least one task, and may be implemented as a computer program executed by a processor. The task that the AI model trains may be a task to be solved or executed through machine training. The AI model may be implemented as a computer program executed on a computing apparatus, may be downloaded through a network, or may be sold as a product. Alternatively, the AI model may be networked with a variety of apparatuses.

As described below, in some embodiments, in a first training stage, an AI model may be trained with relatively low-resolution images downsized from original images. The AI model may be a masked vision transformer, for example, that encodes patches of a given low-resolution image, some of which may be masked. The low-resolution images may be unlabeled images and/or may be a variety of labeled images. The patches (possibly as transformed into positional embedding vectors) of the given low-resolution image may be encoded as tokens, and dummy mask-tokens (tokens corresponding to masked patches) may be added to the encoded tokens. The tokens and the dummy mask-tokens may be decoded (as a group) by the AI model to produce a low-resolution reconstructed image. The reconstructed low-resolution image may be compared to the corresponding given low-resolution image to train the AI model. The first training stage may be performed to determine an optimal set of hyperparameters. In a second training stage, a relatively high-resolution images (compared to the low-resolution images), which may be unlabeled images and/or may be a variety of labeled images, may be used. The pre-training and fine-tuning of the second training stage may be performed using the optimal set of the hyperparameters determined in the first training stage. The images used for training in the first and second stages may be in a domain (e.g., category, subject, etc.) for which the AI model has not previously been trained. Training of the AI model to learn the new domain may be achieved with a relatively small number of images.

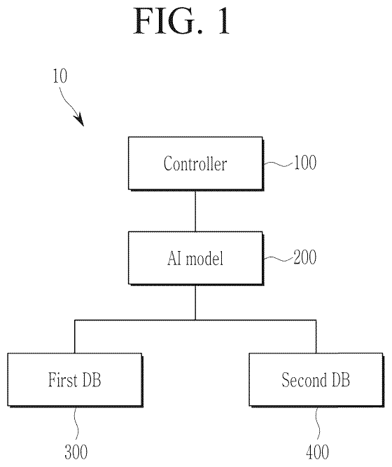

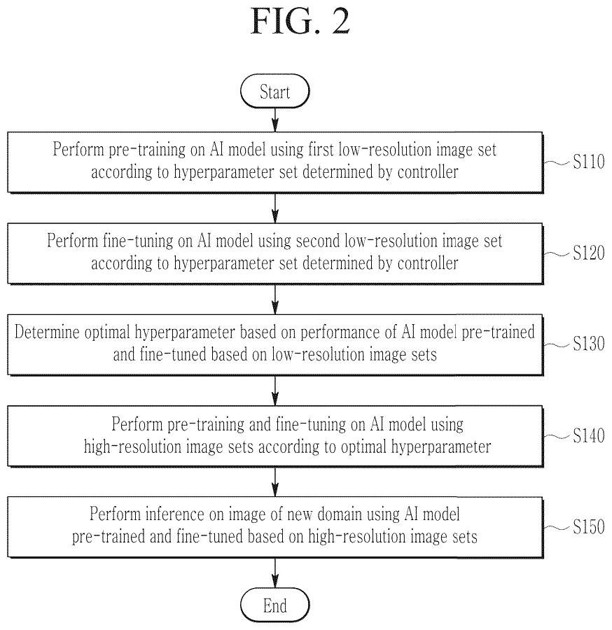

FIG. 1 illustrates a training apparatus of an AI model according to one or more embodiments and FIG. 2 illustrates a training method of the AI model according to one or more embodiments.

Referring to FIG. 1, a training apparatus 10 of the AI model may include a controller 100, an AI model 200, a first DB 300, and a second DB 400.

In some embodiments, the controller 100 may perform pre-training and fine-tuning training on the AI model 200 using a relatively small-resolution image set according to hyperparameter values in a hyperparameter set and may determine an optimal hyperparameter value for training for adaptation of the AI model 200 to a new domain.

In some embodiments, when an image-classification domain is to be changed to a new domain, the controller 100 may adapt the AI model 200 to the new domain by performing pre-training and fine-tuning on the AI model 200 using an image of the new domain. In this case, the pre-training may be performed using a general image set of an existing domain and/or an unlabeled image set of the new domain, and the fine-tuning may be performed using a labeled image set of the new domain. That is to say, even though a new domain is trained-for, training data for training to the new domain may include images in the new domain as well as other images.

In some embodiments, the controller 100 may perform pre-training and fine-tuning on the AI model 200 using a relatively low-resolution image set and may then determine a hyperparameter based on a result of the pre-training and the fine-tuning that used the low-resolution image set. Thus, the controller 100 may reduce the time needed to search for an optimal hyperparameter and may optimize training for adaptation to the new domain. For example, the AI model 200 may be structured/implemented as a vision transformer (ViT). A vision transformer typically includes an encoder that outputs tokens for an image inputted to the vision transformer. If the images in an image set are reduced to ¼ of their original size for the pre-training (e.g., from 1024×10²⁴ to 256×256), the number of tokens output from the encoder may also be reduced to ¼ (as compared to the number of tokens that would be outputted using the original image size) and the time required for the pre-training may also be reduced.

Thereafter, the controller 100 may perform pre-training and fine-tuning on the AI model 200 using an original-size (or high-resolution size) image set corresponding to the low-resolution image set. Thus, the controller 100 may form a correlation between the AI model as trained based on the low-resolution image set and the AI model as trained based on the original image set, and may enable an optimal hyperparameter-which is determined by using the low-resolution image set—to exhibit near-best performance even in training using the original image set. As used herein, “low resolution” and “high resolution” are relative terms defined with respect to each other.

In some embodiments, the AI model 200 may perform pre-training and fine-tuning according to hyperparameters consecutively provided from the controller 100, and may report to the controller 100 a result (e.g., a performance metric of the AI model 200) of the pre-training and the fine-tuning on the AI model 200 as performed with each hyperparameter. In some embodiments, the AI model 200 may be a vision transformer or a ViT-based masked autoencoder (MAE), either of which may be configured/used after training to detect defects in input images.

In some embodiments, a large number of unlabeled images (e.g., millions to billions of unlabeled images) may be stored in the first DB 300. An image set stored in the first DB 300 may be used for pre-training (e.g., training and testing) on the AI model 200. Here, “pre-training” refers to training performed before fine-tuning training.

In some embodiments, a small number (relative to the full-sized images used for training) of labeled images of a new domain that is changed/different from an existing domain (for which the AI model 200 has been trained) may be stored in the second DB 400. An image set stored in the second DB 400 may be used for fine-tuning (e.g., training and testing) on the AI model 200.

Referring to FIG. 2, at step S110, the controller 100 may perform pre-training on the AI model 200 using a first low-resolution image set, and the pre-training may be performed according to hyperparameter sets of values constructed by selecting hyperparameter values from among hyperparameter presets (i.e., sets of values of the respective hyperparameters), described below. The controller 100 may generate the first low-resolution image set (which is used for the pre-training on the AI model 200) by performing resolution downconversion/downscaling on the unlabeled images stored in the first DB 300.

The hyperparameter preset may be predefined by a user, for example, and the controller 100 may determine different hyperparameter sets by selecting hyperparameters from among the hyperparameter preset. For example, the hyperparameter preset may include a learning rate preset, a mask ratio preset, and a weight decay preset (“preset” refers to a predefined value). For example, the learning rate preset may include learning rate values of {1e−5, 5e−5, 1e−6}, the masking ratio preset may include masking ratio values of {0.55, 0.65, 0.75}, and the weight decay preset may include weight decay values of {0.1, 0.2, 0.3}. The controller 100 may determine one of the hyperparameter sets by selecting a hyperparameter value from each of the presets. Hereinafter some embodiments are described in which the controller 100 determines an optimal hyperparameter based on a result of the pre-trainings on the AI model 200 according to three different learning rates values.

The learning rate is a parameter that determines training speed for the AI model 200, and for example, how weights are updated. The learning rate may have a relationship in a gradient descent method as described by Equation 1 below.

$${w}_{t + 1} = {w}_{t} - η \cdot ∇ L \qquad Equation 1$$

Referring to Equation 1, a weight Wₜ₊₁ at a time point t+1 may be calculated by subtracting a product of the learning rate η and a slope of a loss function V̅L from a weight wₜ at a time point t. That is, if a learning rate value that is too large is applied, a weight of the AI model 200 may be updated to a size that is too large so that the possibility of passing an optimal value is increased. Therefore, there may be a high possibility that the loss function diverges without converging. Conversely, if a learning rate value that is too small is applied, a weight of the AI model 200 may be updated to a size that is too small so that the training speed is slowed down and it takes a long time to reach the optimal value. Therefore, the controller 100 according to some embodiments may perform pre-training and fine-tuning on the AI model 200 using a relatively low-resolution image set to determine a hyperparameter that may optimize training for rapid and accurate adaptation (i.e., fine-tuned training) to the new domain.

Referring to FIG. 2, the controller 100 may perform fine-tuning on the AI model 200 using a second low-resolution image set according to hyperparameter sets determined by the controller 100 based on a weight updated through the pre-training on the AI model 200 (S120). The controller 100 may generate the second low-resolution image set used for the fine-tuning on the AI model 200 by performing resolution downconversion on the labeled images stored in the second DB 400.

Referring to FIG. 2, the controller 100 may determine an optimal hyperparameter based on performance of the AI model 200 as pre-trained and fine-tuned based on low-resolution image sets (e.g., the first low-resolution image set and the second low-resolution image set) (S130).

Table 1 below shows performance of the AI model 200 according to low-resolution image set based pre-training and fine-tuning performed at different learning rates.

TABLE 1

| | Resolution | Time required | Time required | Top1 |
|---|---|---|---|---|
| | of input image | for pre-training | for fine-tuning | accuracy |
| Learning rate | (pixel × pixel) | (minute:second) | (minute:second) | (%) |
| 5e−5 | 112 × 112 | 34:00 | 33:10 | 45.67 |
| 1e−5 | 112 × 112 | 34:01 | 32:59 | 54.41 |
| 5e−6 | 112 × 112 | 34:00 | 33:17 | 52.81 |

Referring to Table 1, the controller 100 may repeatedly perform the low-resolution image set based pre-training and fine-tuning (e.g., an input image with a resolution of 112×112) by applying different hyperparameters (i.e., learning rates of 5e−5, 1e−5, and 5e−6) for each such training, and may measure the performance of each such trained AI model 200. In Table 1, the performance of the trained AI model 200 is measured by Top1 accuracy.

Referring to Table 1, the time required for the pre-training on the AI model 200 and the time required for the fine-tuning on the AI model 200 at each learning rate are similar, but the Top1 accuracy is highest when the learning rate is 1e−5 (middle row). Therefore, the controller 100 may determine an optimal learning rate of the AI model 200 as 1e−5, and the optimal learning rate may then be used for a high-resolution image set based pre-training and fine-tuning on the AI model 200.

Additionally, the controller 100 may determine an optimal value of another hyperparameter such as a masking ratio or weight decay with the same method described above. For example, the controller 100 may perform the low-resolution image set based pre-training and fine-tuning on the AI model 200, each time changing the masking ratio from 0.55, then to 0.65, and then to 0.75, and then may compare the measured performances of the trained AI model 200 to determine which of the three values is optimal for the masking ratio. Similarly, the controller 100 may test low-resolution training with different sizes of the weight decay, e.g., from 0.1, 0.2, to 0.3, that is, the controller 100 may perform the low-resolution image set based pre-training and fine-tuning on the AI model 200 for each of the weight decay values, and then may compare the measured performances of the AI model 200 for those respective values to determine an optimal value of the weight decay.

Referring to FIG. 2, the controller 100 may perform the high-resolution image set based pre-training and fine-tuning on the AI model 200 according to an optimal hyperparameter value(s) determined through the low-resolution image set based pre-training and fine-tuning (S140).

The optimal hyperparameter value(s) determined through the low-resolution image set based pre-training and fine-tuning may be used as it is in the high-resolution image set based pre-training and fine-tuning on the AI model 200. That is, the controller 100 may perform the high-resolution image set based pre-training and fine-tuning without changing the hyperparameter so that the optimal hyperparameter determined by the low-resolution image set based pre-training and fine-tuning is smoothly operated even in the high-resolution image set based pre-training and the fine-tuning.

For example, the controller 100 may perform the high-resolution image set based pre-training on the AI model 200 using an original image set stored in the first DB 300, and may perform the high-resolution image set based fine-tuning on the AI model 200 using an original image set stored in the second DB 400 according to weights determined in the high-resolution image set based pre-training. This is because the original image set stored in each DB has a relatively higher resolution than that of a low-resolution image set downconverted therefrom. Original image sizes may be used for high-resolution training, however, other image sizes may be used. That is to say, upscaling and/or downconverting may be used to provide the high-resolution images and the low-resolution images to be set to sizes as needed.

Table 2 shows performance of the AI model 200 after the high-resolution image set based pre-training and fine-tuning are performed on the AI model 200 at each learning rate to verify that the hyperparameter, as determined in the low-resolution image set based pre-training and fine-tuning, is indeed optimal.

TABLE 2

| | Resolution | Time required | Time required | Top1 |
|---|---|---|---|---|
| | of input image | for pre-training | for fine-tuning | accuracy |
| Learning rate | (pixel) | (minute:second) | (minute:second) | (%) |
| 5e−5 | 224 × 224 | 67:48 | 40:34 | 53.19 |
| 1e−5 | 224 × 224 | 68:01 | 40:47 | 58.28 |
| 5e−6 | 224 × 224 | 68:01 | 38:19 | 55.40 |

Referring to Table 2, even when input images with a resolution of 224×224-which have higher resolution than the input images corresponding to Table 1—are used for the pre-training, the performance of the AI model 200 may be best when the learning rate is 1e−5. That is, the optimal hyperparameter value determined in the low-resolution image set based pre-training and fine-tuning on the AI model 200 may also be verified as optimal for the high-resolution image set based pre-training and fine-tuning.

Thereafter, at step S150, non-training inference on an image of the new domain may be performed using the AI model 200 pre-trained and fine-tuned based on the high-resolution image set.

As described above, the controller 100 may quickly perform pre-training and fine-tuning on the AI model at a low computation cost using the low-resolution image set to quickly determine the optimal hyperparameter value(s), as compared with domain adaptation of the AI model based on a high-resolution image set.

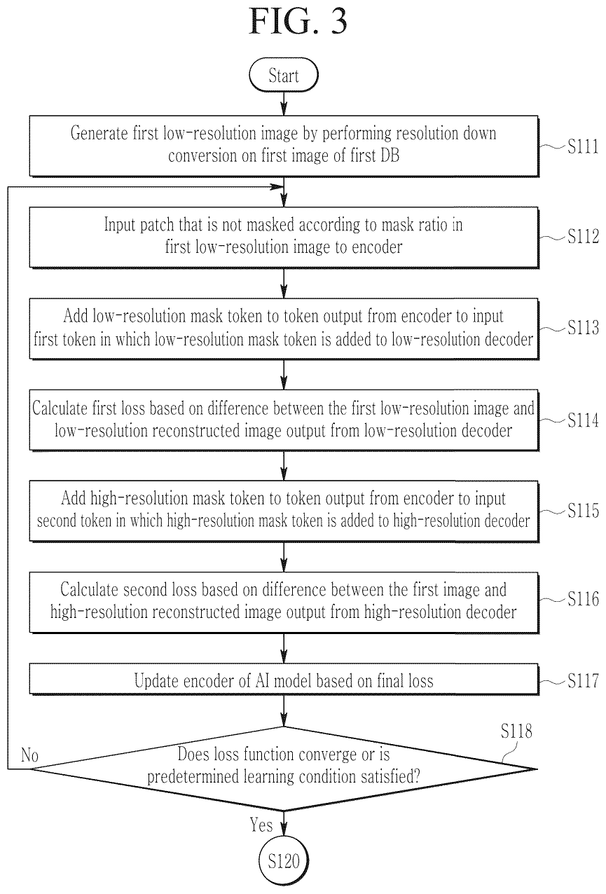

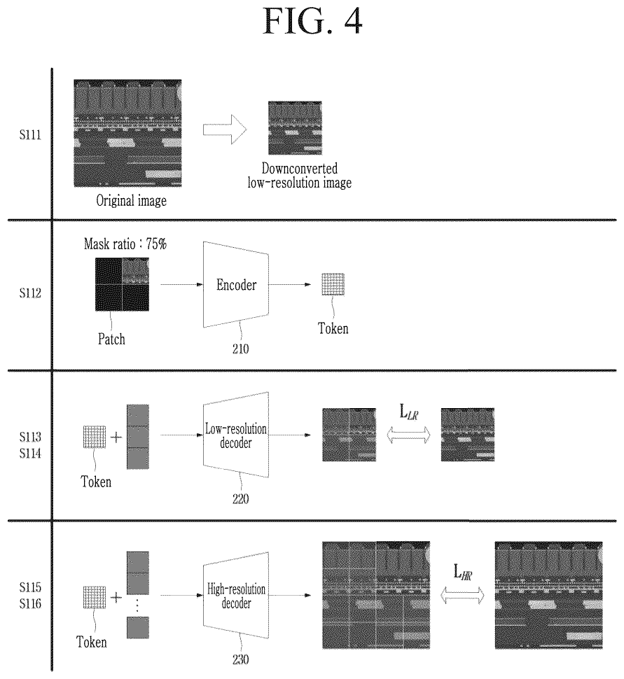

FIG. 3 and FIG. 4 illustrate a low-resolution image set based pre-training method on the AI model according to one or more embodiments.

The method of FIGS. 3 and 4 may be suitable for embodiments that use a vision transformer model as the AI model 200. A vision transformer model generally applies an attention mechanism to vision tasks by treating an image as a sequence of patches, similar to how transformers process words. An image may be divided into patches, which may be embedded into vectors while also adding positional information. The resulting sequence may be processed through a standard transformer encoder to perform tasks like image classification. More specifically, the image patching may involve dividing the image into a grid of fixed-size patches, which are then flattened into vectors. Each patch may be linearly projected into a vector of a fixed dimension, which becomes a “visual token”. Since transformers usually do not have an inherent sense of order, a learnable position embedding may be added to each patch's vector to provide spatial/order information. A special learnable “classification token” may be prepended to the sequence of patch embeddings. The final output of the classification token may be used for classification. The sequence of vectors (patch embeddings+positional embeddings+classification token) may be inputted to a standard transformer encoder, which uses self-attention to learn relationships between the patches. For classification, the final state of the classification token is passed through a classification head to predict the image's label.

Referring to FIG. 3, at step S111 the controller 100 may generate first low-resolution images by, for example, performing resolution downconversion on first images of the first DB 300 for the low-resolution image set based pre-training. Alternatively, low-resolution versions of high-resolution images may be generated in advance and stored for future use. Referring to the example shown in FIG. 4, in some embodiments, at step S111, the controller 100 may downconvert the resolution of the first images of the first DB to ¼ of their original resolution to generate the first low-resolution images.

Referring to FIG. 3, at step S112, the controller 100 may divide the first low-resolution image into patches, some of which may be masked according to a mask ratio (masking may be performed with a random mask array, for example). Patches that are not masked (unmasked patches) in the first low-resolution image may be inputted to an encoder 210 of the AI model 200; masked patches may be bypassed. In some embodiments, the controller 100 may convert the unmasked patches into respective embedding vectors and add to each embedding vector a positional embedding that indicates positional information of the corresponding unmasked patch. For example, the positional information of a token/embedding may correspond to an order or x-y position of the corresponding patch within the low-resolution image.

Referring to FIG. 4, the mask ratio may be 75%, for example, and unmasked patches may be 25% of the total patches. The unmasked patches may be input to the encoder 210. The encoder 210 may output tokens respectively corresponding to the unmasked patches. Referring to FIG. 4, the patch position of each patch corresponding to each token may be inherent in, or embedded in, the tokens output from the encoder 210. In the example of FIG. 4, the unmasked patch is the patch at position (1,2) of the total four patches.

Referring to FIG. 3, as shown by the gray vertical bars next to the “Token” at steps S113-S116, at step S113 the controller 100 may add dummy/artificial low-resolution mask token(s) to the token(s) output from the encoder 210 in order to input a first token (to which the low-resolution mask token is added) to a low-resolution decoder 220. The low-resolution mask token may be a kind of dummy added to the token(s) outputted from the encoder 210 so that the low-resolution decoder 220 can generates a reconstructed image of the same size as that of an original image (e.g., the first low-resolution image). In other words, dummy tokens may be added to the tokens outputted from the encoder 210 so that the image reconstructed by the low-resolution decoder 220 (per the outputted and dummy tokens) matches the size of the downconverted low-resolution image.

Referring to FIG. 4, the decoder 220 may output a low-resolution reconstructed image from the tokens of the encoder 210 as supplemented by the low-resolution dummy/mask tokens. The decoder 220 may generate the entire reconstructed image (which includes portions corresponding to the masked patches) based on the positional embeddings in the respective tokens.

Thereafter, at step S114, the controller 100 may determine a first loss based on a difference between the first low-resolution image and a low-resolution reconstructed image output from the low-resolution decoder 220. The first loss (L_{LR}) may be computed with code/instructions configured as described by Equation 2.

$${L}_{L R} = \frac{1}{{H}_{LR} {W}_{LR}} {\sum }_{i , j}^{{H}_{L R} {W}_{L R}} {( {I}_{L R} ( i , j ) - {\hat{I}}_{L R} ( i , j ) )}^{2} \qquad Equation 2$$

In Equation 2, HLR represents the number of patches in a height direction of the image and W_{LR} represents the number of patches in a width direction of the image. Referring to Equation 2, the first loss (L_{LR}) may be calculated based on a difference between a patch (I_{LR}(i, j)) at an (i, j) position of the first low-resolution image and a patch (Î_{LR} (i, j)) at an (i, j) position of the low-resolution reconstructed image.

In some other embodiments, the first loss may be determined based on a comparison between only masked portions/patches in the first low-resolution image and respectively corresponding portions/patches in the low-resolution reconstructed image (i.e., as in Equation 2, but with unmasked patches excluded from the loss). That is, the first loss may be determined based on a difference between a portion of the first low-resolution image corresponding to the masked patches of the original image and a portion of the reconstructed image corresponding to the masked patches that have been reconstructed from the tokens of the unmasked patches by the low-resolution decoder 220.

Referring to FIG. 3, in the case of the high-resolution training after the low-resolution training, similar to the case of the low-resolution training, at step S115 the controller 100 may add (i) high-resolution mask token(s) (or “original” resolution mask token(s)) to (ii) the tokens outputted from the encoder 210. The augmented tokens (second tokens) to which the high-resolution mask token(s) are added may be inputted to a high-resolution decoder 230. The high-resolution mask tokens may be dummies added to the encoded tokens so that the high-resolution decoder 230 generates a reconstructed image of the same size as that of an original high-resolution image (e.g., a first image).

Referring to FIG. 4, the high-resolution decoder 230 may output a high-resolution reconstructed image from the tokens of the encoder 210 (to which have been added the high-resolution mask/dummy tokens). The high-resolution decoder 230 may reconstruct the entire reconstructed image including a portion corresponding to the masked patches, and may do so based on the positional embeddings in the tokens (the mask/dummy tokens may also have positional embeddings). The high-resolution decoder 230 may recognize the positional embedding in a token by upscaling it to a higher resolution. For example, the positional information (1,2) of the unmasked patch may be upscaled to (1,3), (1,4), (2,3), and (2,4), in the case where the high-resolution is twice the low-resolution.

Thereafter, at step S116, the controller 100 may determine a second loss based on a difference between the first image and a high-resolution reconstructed image output from the high-resolution decoder 230. The second loss (LHR) may be computed with code/instructions configured as described by Equation 3.

$${L}_{H R} = \frac{1}{{H}_{H R} {W}_{HR}} {\sum }_{i , j}^{{H}_{H R} {W}_{HR}} {( {I}_{HR} ( i , j ) - {\hat{I}}_{H R} ( i , j ) )}^{2} \qquad Equation 3$$

In Equation 3, HHR represents the number of patches in a height direction of the image, and WHR represents the number of patches in a width direction of the image. Referring to Equation 3, the second loss (LHR) may be calculated based on a difference between a patch (I_{HR} (i, j)) at an (i, j) position of the first image and a patch (Î_{HR}(i, j)) at an (i, j) position of the high-resolution reconstructed image.

In some other embodiments, the second loss may be determined based on a comparison between masked patches in the first image and respectively corresponding patches in the high-resolution reconstructed image. That is, the second loss may be determined based on a difference between a portion corresponding to the masked patches of the original image (e.g., the first image) and a portion corresponding to the masked patches reconstructed from the tokens of the unmasked patches by the high-resolution decoder 230.

Referring to FIG. 3, at step S117, the controller 100 may update the encoder 210 of the AI model 200 based on a final loss. The final loss L may be computed with code/instructions configured as described Equation 4.

$$L = {L}_{L R} + {L}_{H R} \qquad Equation 4$$

Thereafter, at step S118, the controller 100 may determine whether to terminate the pre-training for the AI model 200 depending on whether the loss function converges or based on whether a predetermined training condition is satisfied. When the low-resolution image set based pre-training for the AI model 200 is terminated, the controller 100 may perform the low-resolution image set based fine-tuning on the AI model 200.

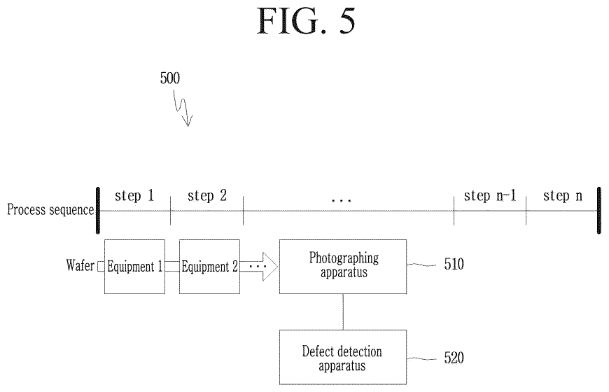

FIG. 5 illustrates a defect detection system of a semiconductor manufacturing process according to one or more embodiments.

Referring to FIG. 5, a defect detection system 500 of the semiconductor manufacturing process may include a photographing apparatus 510 and a defect detection apparatus 520.

When an in-fab (in-fabrication) wafer is processed by each process equipment (e.g., an equipment 1, an equipment 2, or the like) according to a process sequence (e.g., step 1, step 2, . . . , step n-1, step n, wherein n is an integer greater than 1), the photographing apparatus 510 may photograph images of the wafer during the process sequence. The photographing apparatus 510 may be a scanning electron microscope (SEM), an optical microscope (OM), a transmission electron microscope (TEM), an X-ray inspection device, or the like.

When an image generated by the photographing apparatus 510 is input to the defect detection apparatus 520, the defect detection apparatus 520 according to some embodiments may detect a defect in the input image using the AI model 200.

The AI model 200 according to some embodiments may be pre-trained and fine-tuned to classify images (e.g., an image of a new domain) generated from a new product, a new process, a new equipment, or the like. The images of the new domain may include a large number of unlabeled images and a small number of labeled images. As described above, the controller 100 may perform pre-training on the AI model 200 using a large number of unlabeled new domain images and may perform fine-tuning on the AI model 200 using a small amount of labeled new domain images. Additionally, the controller 100 may perform the low-resolution image set based pre-training and fine-tuning to determine the optimal hyperparameter value(s) and may perform the high-resolution image set based pre-training and fine-tuning using the determined optimal hyperparameter value(s).

When the optimal hyperparameter value(s) are determined through the low-resolution image set based pre-training and the fine-tuning, and when the high-resolution image set based pre-training and fine-tuning on the AI model 200 according to the determined optimal hyperparameter value(s) is completed, the defect detection apparatus 520 may classify an image belonging to the new domain using the AI model 200 for which the pre-training and the fine-tuning have been performed.

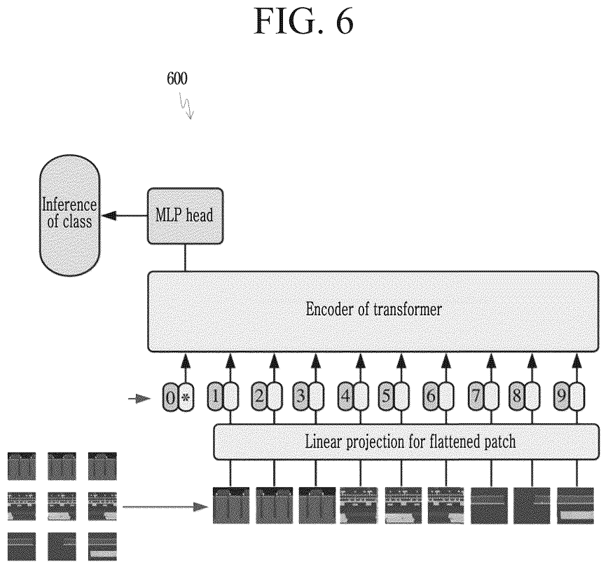

FIG. 6 illustrates a structure of a vision transformer according to one or more embodiments.

Referring to FIG. 6, the AI model 200 according to an embodiment may include or have the structure 600 of a vision transformer.

The controller 100 may divide the input image into patches (e.g., in grid fashion) and may generate tokens respectively corresponding to the patches to determine a class of the input image. To generate the tokens from the patches, each patch may be flattened into a vector form; each such fixed-dimension embedding vector may be generated through a linear transformation (e.g., a linear projection for the flattened patch). Positional embedding (e.g., the portions marked by 0, 1, . . . , 9 in FIG. 6) may be added to each embedding vector so that a relative position between the patches can be recognized during decoding.

Thereafter, features of an input image may be trained using the encoder of the transformer. In the encoder of the transformer, multi-head self-attention may be applied, and an attention operation may be performed so that a relationship between different patches is trained.

Thereafter, an attention output may be passed through an MLP (feedforward network (FFN)) so that an additional nonlinear transformation is performed, and layer normalization and residual connection may be used so that the training is stabilized.

Thereafter, the loss can be calculated (generally, a cross-entropy loss may be used) and the slope of the loss function may be backpropagated so that weights are updated.

Although the description above describes various input to various AI models, it will be appreciated that “input to” and similar phrases are not to be strictly interpreted. The phrase “input” in reference to AI models herein is deemed to also describe variations in which “inputs” are modified, augmented, transformed, etc., so long as the relevant underlying information in the “input”, or any significant characteristics thereof, are not significantly lost. For example, a vector and a token sequence might be refined or translated into another form before serving as an AI model “input”. Similarly, data described as “output” from an AI model (e.g., a reconstructed image) is considered to include variations and transformations of the output that do not prevent the purpose for which the output is used.

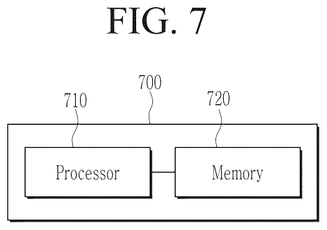

FIG. 7 illustrates a controller for pre-training and fine-tuning for the AI model according to one or more embodiments.

The controller for the pre-training and the fine-tuning for the AI model according to some embodiments may be implemented as a computer system (e.g., a computer-readable medium). Referring to FIG. 7, a computer system 700 may include at least one processor 710 and a memory 720. The memory 720 may be connected to the processor 710 to store various information for driving the processor 710 or at least one program executed by the processor 710. Alternatively, the memory 720 may store code/instructions configured to cause the processor 710 to perform a function, a process, or a method described in the embodiment.

The processor 710 may implement the function, the process, or the method proposed in the embodiment. An operation of the computer system 700 according to an embodiment may be implemented by the processor 710. The at least one processor 710 may include at least one of a GPU, a CPU, and an NPU. When the operation of the computer system 700 is implemented by the at least one processor 710, each task may be divided among the at least one processor 710 according to a load. For example, when one processor is a CPU, the other processor may be any one of a GPU, an NPU, an FPGA, and a DSP.

In some embodiments, the memory 720 may be disposed inside or outside the processor, and the memory may be connected to the processor through various means already known. The memory may be a volatile or nonvolatile storage medium of various forms, and for example, the memory may include a read-only memory (ROM) or a random access memory (RAM).

Embodiments may be implemented by programs (in the form of source code, executable instructions, intermediate code, etc.) realizing the functions corresponding to the configuration of the embodiments or a recording medium (not a signal per se) recorded with the programs, which may be readily implemented by a person having ordinary skill in the art to which the present disclosure pertains from the description of the foregoing embodiments. That is to say, with the description above, an engineer or the like may readily, for example, formulate source code corresponding to the description, compile the source code into instructions, and the instructions, when executed by the processor 710 will cause the processor to perform physical operations analogous to the description above. Specifically, the method (e.g., an image preprocessing method or the like) according to some embodiments may be implemented in the form of program instructions that may be executed through various computer means to be recorded on a computer-readable medium. The computer-readable medium may include program instructions, data files, data structures, and the like, independently or in combination thereof. The program instructions recorded on the computer-readable medium may be specially designed and configured for the embodiment, or may be known to those skilled in the art of computer software so as to be used. The computer-readable recording medium may include a hardware device configured to store and execute the program instructions. For example, the computer-readable recording medium may be a hard disk, a magnetic media such as a floppy disk and a magnetic tape, an optical media such as a CD-ROM and a DVD, a magneto-optical media such as a floptical disk, a ROM, a RAM, a flash memory, or the like. The program instructions may include a high-level language code that may be executed by a computer using an interpreter or the like, as well as a machine language code generated by a compiler.

The computing apparatuses, the electronic devices, the processors, the memories, the displays, the information output system and hardware, the storage devices, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method performed by one or more processors for determining an optimal hyperparameter value for a hyperparameter among hyperparameters of an artificial intelligence (AI) model, the method comprising:
performing first pre-trainings of the AI model using a first low-resolution image set according to sets of values of hyperparameters, each set of values comprising values respectively corresponding to the hyperparameters, wherein the low-resolution image set comprises first low-resolution images that are low-resolution relative to a resolution that the AI model is capable of performing inference on;
performing first fine-tunings of the AI model using a second low-resolution image set, wherein the first fine-tunings are performed according to the respectively corresponding sets of values of the hyperparameters; and
determining the optimal hyperparameter value based on metrics of performance of the AI model for which the first pre-trainings and the first fine-tunings have been performed.

2. The method of claim 1, wherein
the performing first pre-trainings of the AI model using the first low-resolution image set according to sets of values of the hyperparameters comprises
performing the first pre-trainings using first images of a first database and the first low-resolution images having a resolution relatively lower than the first images of the first database.

3. The method of claim 2, wherein
the performing the first pre-trainings using the first images of the first database and the first low-resolution images having a resolution relatively lower than the first images of the first database comprises:
calculating a first loss using one of the first low-resolution images;
calculating a second loss using one of the first images of the first database; and
updating an encoder of the AI model based on the first loss and the second loss.

4. The method of claim 3, wherein one of the hyperparameters is a mask ratio that controls how many patches of the one of the first low-resolution images are masked, and wherein
the calculating of the first loss using the one of the first low-resolution images comprises:
inputting, to the encoder, a non-masked patch of the one of the first low-resolution images, wherein the non-masked patch is determined to be non-masked according to a value of the mask ratio, wherein the value of the mask ratio is one of the value sin the sets of values;
adding a low-resolution mask token to tokens output from the encoder and inputting the tokens with the low-resolution mask token to a first decoder of the AI model which generates a low-resolution reconstructed image based thereon; and
calculating the first loss based on a difference between the one of the first low-resolution images and the low-resolution reconstructed image.

5. The method of claim 4, wherein
the inputting the non-masked patch to the encoder comprises:
converting the non-masked patch into an embedding vector; and
adding to the embedding vector a positional embedding indicating positional information of the unmasked patch and inputting the embedding vector with the positional embedding to the encoder.

6. The method of claim 4, wherein
the calculating the second loss using the one of the first images of the database comprises:
adding a high-resolution mask token to second tokens outputted from the encoder based on the one of the first images of the database, and inputting the second tokens to which the high-resolution mask token is added to a second decoder of the AI model that generates a second reconstructed image based thereon; and
calculating the second loss based on a difference between the one of the first images and the second reconstructed image.

7. The method of claim 6, wherein
the first loss is determined based on a comparison between the low-resolution reconstructed image and a portion of the one of the first low-resolution images that corresponds to masked patches in the one of the first low-resolution images, and
the second loss is determined based on a comparison between the second reconstructed image and a portion of the one of the first images of the database that correspond to masked patches in the one of the first images of the database.

8. The method of claim 1, further comprising:
performing second pre-training on the AI model with the optimal hyperparameter value using a first high-resolution image set of images that are higher resolution than the images in the low-resolution image set; and
performing second fine-tuning on the AI model with the optimal hyperparameter value using a second high-resolution image set of images that are higher resolution than the images in the low-resolution image set.

9. The method of claim 1, further comprising:
performing downconversion for images in a first database to generate the first low-resolution image set; and
performing downconversion for images in a second database to generate the second low-resolution image set,
wherein the first database stores unlabeled images and the second database stores labeled images.

10. An apparatus for determining an optimal hyperparameter value, the apparatus comprising:
one or more processors and a memory,
wherein the memory stores instructions configured to cause the one or more processors to perform a process, and the process comprises:
performing a low-resolution image set based pre-training and a low-resolution image set based fine-tuning on an artificial intelligence (AI) model for each of hyperparameter sets of values of hyperparameters, wherein a low-resolution image set based pre-training and a low-resolution image set based fine-tuning are performed for each set of values of the hyperparameters, wherein a performance metric of the AI model is determined for each low-resolution image set based pre-training and its corresponding a low-resolution image set based fine-tuning, and wherein the low-resolution image set is low-resolution relative to a resolution that the AI model is capable of performing inference on; and
determining the optimal hyperparameter value based on the performance metrics of the AI model.

11. The apparatus of claim 10, wherein
the performing each low-resolution image set based pre-training and its corresponding a low-resolution image set based fine-tuning on the AI model according to the sets of hyperparameter values comprises:
performing each pre-training on the AI model using a first image of a first database and a first low-resolution image downconverted from the first image; and
performing each fine-tuning on the AI model using a second image of a second database and a second low-resolution image downconverted from the second image.

12. The apparatus of claim 11, wherein
the performing each pre-training on the AI model using a first image of the first database and a first low-resolution image downconverted from the first image comprises:
calculating a first loss using the first low-resolution image;
calculating a second loss using the first image; and
updating an encoder of the AI model based on the first loss and the second loss.

13. The apparatus of claim 12, wherein
the calculating the first loss using the first low-resolution image comprises:
inputting, to the encoder, a non-masked patch that is determined to be not masked in the first low-resolution image according to a mask ratio value, wherein the mask ratio value is a value in one of the sets of values;
adding a low-resolution mask token to tokens outputted from the encoder and inputting the tokens including the low-resolution mask token to a first decoder of the AI model which infers a low-resolution reconstructed image based thereon; and
calculating the first loss based on a difference between the first low-resolution image and the low-resolution reconstructed image.

14. The apparatus of claim 13, wherein
the calculating the second loss using the first image comprises:
adding a high-resolution mask token to first tokens output from the encoder and inputting, to a second decoder of the AI model, the first tokens including the high-resolution mask token, wherein the second decoder outputs a reconstructed image based on the first tokens including the high-resolution mask token; and
calculating the second loss based on a difference between the first image and the reconstructed image.

15. The apparatus of claim 14, wherein
the first loss is determined based on a comparison between the low-resolution reconstructed image and a portion of the first low-resolution image corresponding to masked patches in the first low-resolution image, and
the second loss is determined based on a comparison between the reconstructed image and a portion of the first image corresponding to masked patches in the first image.

16. The apparatus of claim 10, wherein the process further includes performing pre-training and fine-tuning on the AI model with the optimal hyperparameter value using high-resolution image sets.

17. A system for detecting a defect in a semiconductor manufacturing process, the system comprising:
a photographing apparatus configured to photograph an image of a wafer during the semiconductor manufacturing process; and
a defect detection apparatus configured to detect a defect in the image using an AI model,
wherein the AI model is trained to classify an image of a new domain through low-resolution image set based pre-training and fine-tuning and high-resolution image set based pre-training and fine-tuning, wherein the low-resolution image set has lower resolution than the high-resolution image set.

18. The system of claim 17, wherein
a hyperparameter value for training the AI model is determined through the low-resolution image set based pre-training and the fine-tuning, and the high-resolution image set based pre-training and the fine-tuning are performed using the hyperparameter value determined in the low-resolution image set based pre-training and the fine-tuning.

19. The system of claim 17, wherein the AI model comprises a masked vision transformer neural network.

20. The system of claim 19, wherein the AI model is trained according to a loss computed by comparing regions of a training image that were masked for the pre-training with positionally corresponding regions of an image reconstructed for the training image.
